(19) United States
(12) Patent Application Publication
(10) Pub. No.: US 2013/0251264 A1
(43) Pub. Date: Sep. 26, 2013

(54) ANALYSIS OF HAND-DRAWN INPUT GROUPS

(71) Applicants: Kember Anne-Rivers Forcke, Richmond, VA (US); Susann Marie Keohane, Austin, TX (US); Elizabeth Vera Woodward, Austin, TX (US)

(72) Inventors: Kember Anne-Rivers Forcke, Richmond, VA (US); Susann Marie Keohane, Austin, TX (US); Elizabeth Vera Woodward, Austin, TX (US)

(73) Assignee: International Business Machines Corporation, Armonk, NY (US)

(21) Appl. No.: 13/429,582

(22) Filed: Mar. 26, 2012

(51) Int. Cl. G06K 9/00

(52) U.S. Cl. 382/187

(57) ABSTRACT

A method for analyzing groups of hand-drawn inputs receives from a set of computing devices a corresponding set of hand-drawn inputs. A user in a group of users interacts with a device in the set of devices to provide a hand-drawn input in the set of hand-drawn inputs corresponding to the device. The method analyzes a subset of the set of hand-drawn inputs to determine an accuracy of the hand-drawn inputs in the subset. The method generating a result responsive to the analyzing and presents the result.

### BACKGROUND

1. Technical Field

The present invention relates generally to a computer implemented method, system, and computer program product for hand-drawn input analysis. Particularly, the present invention relates to a computer implemented method, system, and computer program product for analyzing groups of hand-drawn inputs.

2. Description of the Related Art

A hand-drawn input is an input drawn by a human limb with or without the use of an implement. Shapes traced using a fingertip, a pointing device, a stylus, whether by contacting a surface or not, are some examples of hand-drawn inputs.

Many devices that accept hand-drawn inputs have proliferated in our day-to-day lives. Some devices incorporate touch sensitive screens or surfaces that accept inputs when those screens or surfaces are touched. Some other devices incorporate sensors that sense a movement of a limb or implement without using a touch sensitive surface, and accept those movements as inputs. Inputs provided by touching a surface or moving relative to a sensor are hand-drawn inputs within the scope of this disclosure.

### SUMMARY

The illustrative embodiments provide a method, system, and computer program product for analysis of hand-drawn input groups. An embodiment receives from a set of computing devices a corresponding set of hand-drawn inputs, wherein a user in a group of users interacts with a device in the set of devices to provide a hand-drawn input in the set of hand-drawn inputs corresponding to the device. The embodiment analyzes a subset of the set of hand-drawn inputs to determine an accuracy of the hand-drawn inputs in the subset. The embodiment generates a result responsive to the analyzing. The embodiment presents the result.

### BRIEF DESCRIPTION OF THE SEVERAL VIEWS OF THE DRAWINGS

The novel features believed characteristic of the embodiments are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a block diagram of an example configuration for analyzing hand-drawn input groups in accordance with an illustrative embodiment;

FIG. 4 depicts a block diagram of an example configuration for analyzing student hand-drawn input groups in a teaching environment in accordance with an illustrative embodiment; and

FIG. 5 depicts a flowchart of an example process for analyzing hand-drawn input groups in accordance with an illustrative embodiment.

### DETAILED DESCRIPTION

As an example, traditionally, children are taught to trace letters and shapes using paper and writing implements. Presently a teacher has to visit each student or collect each piece of paper and evaluate the student's performance individually using that paper. The illustrative embodiments recognize that such evaluation of a student's performance is time consuming, and a comparative evaluation of the performances of different students in a class is difficult.

Even when the teaching is aided by child-friendly, age-appropriate and appealing devices that allow a student to provide a hand-drawn input, the inputs are individually evaluated within each individual device. The problems recognized by the illustrative embodiments exist with these devices as well. A teacher still has to consider each student's performance individually on the device assigned to the student, and comparative evaluation between different students of the class remains difficult.

Many other environments exist where similar analysis is beneficial. For example, in a hospice or nursing home environment, tests for evaluating dexterity, motor control, dementia, and degenerative ailments are administered to the residents. Such tests involve receiving some hand-drawn inputs from a resident, whether on paper or a device, and presently, such tests are administered individually to the residents. The residents' inputs are evaluated individually to assess an individual resident's condition. The illustrative embodiments recognize that comparative analysis of different residents' performance is difficult to conduct using presently available methods.

The illustrative embodiments further recognize that group analysis of hand-drawn inputs of several individuals, such as students or residents in the above examples, would be advantageous. For example, analyzing hand-drawn inputs of a group of individuals can be useful for determining the effectiveness of treatments or teaching methods, accuracy of tests or teaching aid, identifying individuals who may require additional help or attention, or early detection of a disability or ailment.

The illustrative embodiments used to describe the invention generally address and solve the above-described problems and other problems related to processing collections of hand-drawn inputs, such as for benchmarking an individual's performance, trending of changes in an individual's performance, or comparatively evaluating the performances of different individuals. The illustrative embodiments provide a method, system, and computer program product for analysis of hand-drawn input groups.

Computing devices (devices) capable of accepting hand-drawn inputs are gaining rapid acceptance in a variety of environments. Furthermore, networked computing devices already communicate with each other to share a variety of information. An embodiment can be implemented using a set of devices that accept hand-drawn inputs, a network that can communicate with the devices to transmit the hand-drawn inputs from the devices to a data processing system, and the data processing system performing analysis on groups of hand-drawn inputs received from a subset of the devices.

The illustrative embodiments are described with respect to certain hand-drawn inputs only as examples. Such descriptions are not intended to be limiting on the illustrative embodiments. For example, an embodiment can also be implemented with hand-drawn inputs provided using traditional paper and writing implements. For example, scanning paper-based hand-drawn inputs and performing Optical Character Recognition (OCR) can transform the paper-based hand-drawn inputs into hand-drawn inputs that are usable in accordance with an embodiment. Transforming paper-based hand-drawn inputs can be substituted for receiving the hand-drawn inputs on a touch or movement detecting computing device in an embodiment. Any suitable method of creating a hand-drawn input can be used within the scope of the illustrative embodiments.

Similarly, the illustrative embodiments are described with respect to certain analyses, values, and data only as examples. Such descriptions are not intended to be limiting on the illustrative embodiments. An embodiment can perform any number or type of analysis on the hand-drawn inputs without limitation. For example, an embodiment can perform a supplemental analysis of a group of hand-drawn inputs received from the same individual over a period, to with, analysis of a group of historic hand-drawn inputs, to detect the possibility of existence of a medical condition. For example, hand-drawn inputs of an individual may reveal that the individual's hand-drawn inputs are always below and to the left of a template over which the hand-drawn inputs are traced. Such trend is indicative of Sensory Processing Disorder (SPD), which can be difficult to test for and detect using presently available methods.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

For example, some embodiments are described using letter templates and shape or location of hand-drawn inputs for tracings those letter templates only as a non-limiting example. An embodiment can be adapted to use color selection and insertion hand-drawn inputs, pressure or intensity imparting hand-drawn inputs, or any other form of hand-drawn inputs within the scope of the illustrative embodiments.

As an example, where a user has to select the color green, and the user historically provides hand-drawn inputs selecting the color blue, or vice versa, a supplementary analysis in an embodiment may reveal a color blindness condition in the user. As another example, if a template requires a certain intensity or pressure to be exerted on a touch-screen, and a user consistently imparts less intensity or pressure, an embodiment can perform a supplemental analysis to detect the onset of arthritis in the user.

The illustrative embodiments are further described with respect to certain applications only as examples. Such descriptions are not intended to be limiting on the invention. An embodiment of the invention may be implemented with respect to any type of application, such as, for example, applications that are served, the instances of any type of server application, a platform application, a stand-alone application, an administration application, or a combination thereof.

As an example, an embodiment can be used with a sobriety detection application. Presently, law enforcement personnel administer a sobriety test by subjectively analyzing a person's walk along a line selected by the law enforcement personnel. An embodiment can be used in conjunction with a device capable of accepting a person's footsteps as hand-drawn inputs tracing a pattern or template on the device. Comparing the person's hand-drawn input with several other hand-drawn inputs of several other individuals in varying states of sobriety can provide an objective result of the sobriety test.

An application, including an application implementing all or part of an embodiment, may further include data objects, code objects, encapsulated instructions, application fragments, services, and other types of resources available in a data processing environment. For example, a Java® object, an Enterprise Java Bean (EJB), a servlet, or an applet may be manifestations of an application with respect to which the invention may be implemented. (Java and all Java-based trademarks and logos are trademarks or registered trademarks of Oracle and/or its affiliates).

An illustrative embodiment may be implemented in hardware, software, or a combination thereof. An illustrative embodiment may further be implemented with respect to any type of data storage resource, such as a physical or virtual data storage device, that may be available in a given data processing system configuration.

The illustrative embodiments are described using specific code, designs, architectures, layouts, schematics, and tools only as examples and are not limiting on the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures.

The examples in this disclosure are used only for the clarity of the description and are not limiting on the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

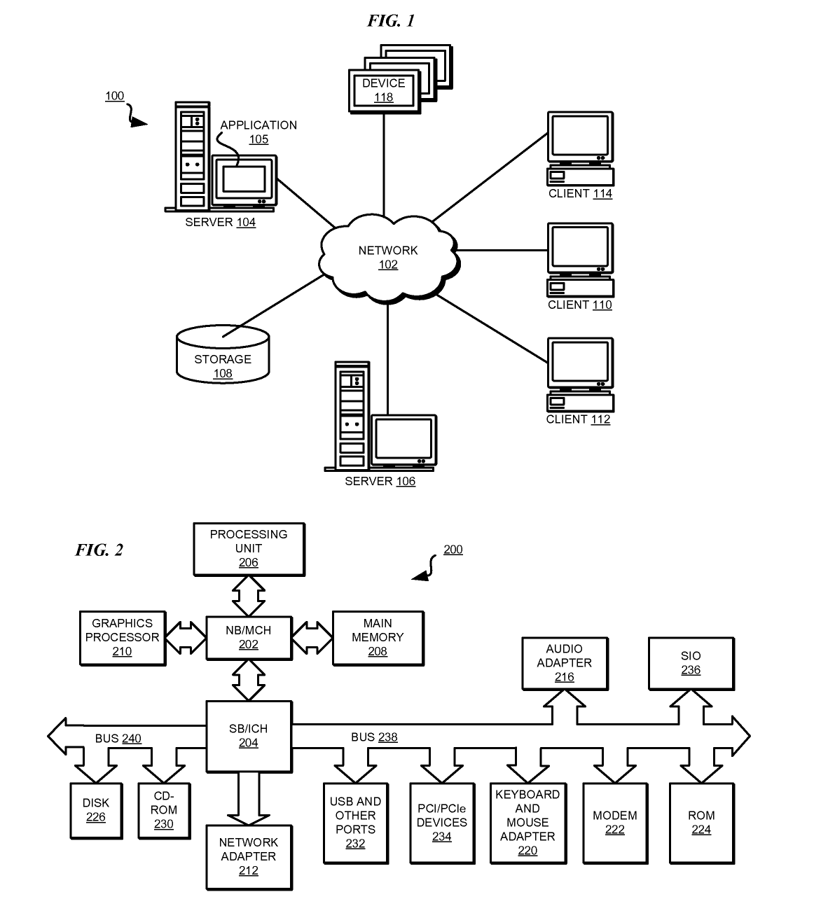

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Any number of devices 118 may couple to network 102 using any suitable method. Device 118 may be any data processing system that can accept a hand-drawn input, such by includes a touch interface or a movement sensor. Some examples of device 118 include, but are not limited to touch screen displays or tablet computers, smartphones with touch screen, portable devices with touch screens, and gaming consoles including sensors for detecting motions of a pointing device or a human limb. Application 105 is an example application implementing one or more embodiments.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes of the illustrative embodiments may be located for the illustrative embodiments.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCl/PCIe devices 234 are coupled to south bridge and I/O controller hub 204 through bus 238. Hard disk drive (HDD) 226 and CD-ROM 230 are coupled to south bridge and I/O controller hub 204 through bus 240. PCl/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as Microsoft® Windows® (Microsoft and Windows are trademarks of Microsoft Corporation in the United States, other countries, or both), or Linux® (Linux is a trademark of Linus Torvalds in the United States, other countries, or both). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle and/or its affiliates).

Program instructions for the operating system, the object-oriented programming system, the processes of the illustrative embodiments, and applications or programs are located on storage devices, such as hard disk drive 226, and may be loaded into a memory, such as, for example, main memory 208, read only memory 224, or one or more peripheral devices, for execution by processing unit 206. Program instructions may also be stored permanently in non-volatile memory and either loaded from there or executed in place. For example, the synthesized program according to an embodiment can be stored in non-volatile memory and loaded from there into DRAM.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

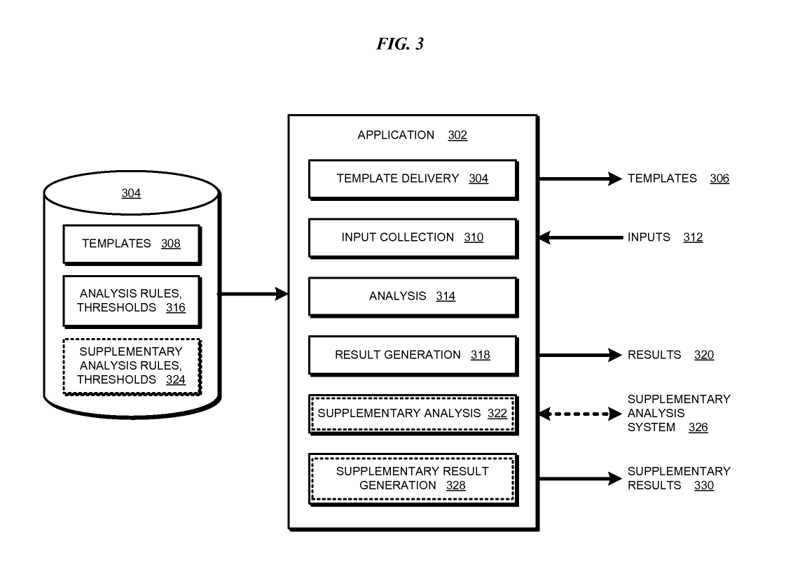

With reference to FIG. 3, this figure depicts a block diagram of an example configuration for analyzing hand-drawn input groups in accordance with an illustrative embodiment. Application 302 can be implemented as application 105 in FIG. 1. Repository 304 may be implemented using storage 108 in FIG. 1.

The components in application 302 as depicted in FIG. 3 and as described herein are not intended to be limiting on the illustrative embodiments. Those of ordinary skill in the art will be able to conceive from this disclosure other ways of achieving similar functions in application 302 and the same are contemplated within the scope of the illustrative embodiments.

Application 302 includes component 304 for providing one or more templates or guidelines 306 to one or more devices (not shown) capable of receiving hand-drawn inputs. For example, in one embodiment, component 304 delivers template 306 by selecting one of templates 308 in repository 304, and optionally manipulating the selected template, such as for making the selected template suitable for use on a particular device.

Component 310 performs the function of collecting inputs 312 from the one or more devices that received templates 306. Inputs 312 may be any number and type of inputs received from any number of devices, and corresponding to one or more of templates 306. For example, differently types of devices may receive different versions of template 306, and provide different hand-drawn inputs 312 corresponding to the different versions of template 306. Component 310 can be configured to receive and process any type of inputs 312 expected in a given environment.

Analysis component 314 selects one or more analysis rules 316 from repository 304. Analysis component 314 selects a group of one or more of inputs 312 received and processed by input collection component 310. Analysis component 314 applies the selected analysis rule 316 to the selected group of inputs 312. Analysis rules 316 may be rules, thresholds, or a combination thereof.

One example analysis rule 316 may create levels of accuracies in the shapes and placements of those shapes received in hand-drawn inputs 312. For example, the analysis may measure an amount of deviation of a point on hand-drawn input 312 from a corresponding point on template 306. If the amount of deviation is between a first threshold and a second threshold, analysis rule 316 determines that the particular hand-drawn input in question is accurate to a first degree. Similarly, if the amount of deviation is between the second threshold and a third threshold, analysis rule 316 determines that the particular hand-drawn input in question is accurate to a second degree, and so on.

Another example analysis rule 316 may group some or all of hand-drawn inputs 312 into different categories, such as by user groups or template groups, or some other criterion. Analysis rule 316 may then apply different thresholds for different categories of hand-drawn inputs 312 to analyze the relative accuracies of the shapes and placement of shapes in the hand-drawn inputs in each category. Analysis rule 316 may then compare relative accuracies across categories.

An example analysis rule 316 can also use hand-drawn inputs 312 in conjunction with historical hand-drawn inputs stored in a repository (not shown). For example, an analysis rule 316 can perform individual analysis of one of hand-drawn input 312 relative to one or more historical hand-drawn inputs from the same user or device to determine specific characteristics of that hand-drawn input. As another example, an analysis rule 316 can perform individual analysis of one of hand-drawn input 312 relative to one or more historical hand-drawn inputs from the same user or device to perform supplemental analysis of that hand-drawn input.

Result generation component 318 prepares and outputs results 320. For example, results 320 may be displayed on client 114 in FIG. 1. In an example class room, templates 306 may be provided to devices assigned to various students, hand-drawn inputs 312 received there from, and results 320 may be provided to a teacher's workstation for students' performance evaluation.

Optionally, component 322 performs supplementary analysis in one embodiment. An implementation may reuse analysis component 314 for performing supplementary analysis functions of component 322 by using supplementary analysis rules and thresholds 324 in repository 304. Detecting a disability in a user from the hand-drawn input received from that user is one example of supplementary analysis. Determining an effectiveness of a treatment by evaluating comparative improvement between several hand-drawn inputs received from a user over a period is another example of supplementary analysis according to an embodiment. The example analyses described in this disclosure are not intended to imply a limitation on specific types of analyses qualifying as primary analyses and others qualifying as supplementary analyses. Depending on a particular implementation, any analysis can be regarded as primary analysis according to analysis rules and thresholds 316, and any analysis can be regarded as supplementary analysis according to analysis rules and thresholds 324.

In one embodiment, supplementary analysis component 322 interacts with another supplementary analysis system 326 for performing the supplementary analysis function. For example, supplementary analysis system 326 may be an expert system for medical diagnosis. Component 322 may provide one or more hand-drawn inputs 312, in raw or transformed form, to the expert system, which may then provide a medical diagnosis of a condition of the user corresponding to the provided hand-drawn inputs.

Supplementary result generation component 328 prepares and outputs supplementary results 330 generated from an operation of supplementary analysis component 322. Supplementary result generation component 328 prepares and outputs supplementary results 330 in a manner similar to result generation component 318. In one embodiment, result generation component 318 can be reused as supplementary result generation component 328.

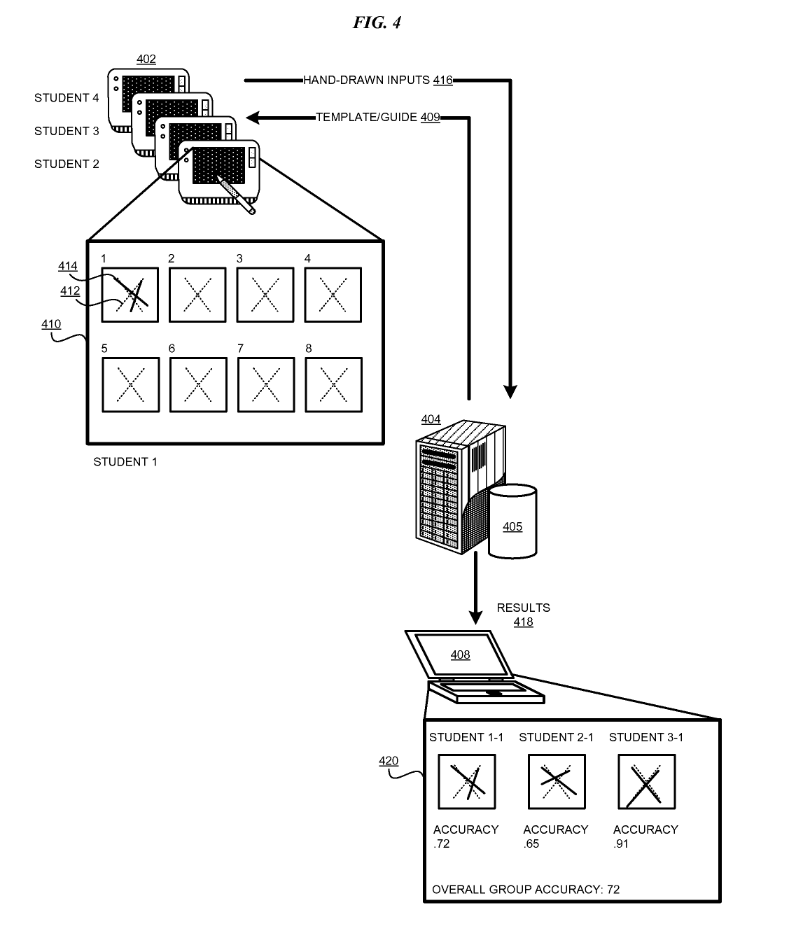

With reference to FIG. 4, this figure depicts a block diagram of an example configuration for analyzing student hand-drawn input groups in a teaching environment in accordance with an illustrative embodiment. Devices 402 may be analogous to devices 118 in FIG. 1. Data processing system 404 may be similar to server 104 in FIG. 1. Data processing system 404 includes an application for analyzing hand-drawn input groups (not shown), such as application 302 in FIG. 3. Repository 406 is analogous to repository 304 in FIG. 3. Data processing system 408 may be implemented using client 114 in FIG. 1.

Data processing system 404 presents templates/guides 409 to devices 402 in the manner of application 302 presenting templates 306 in FIG. 3. Each of devices 402 is assigned to a student, namely, “student 1,” “student 2,” “student 3,” and “student 4.” As an example, screen 410 of one instance of device 402, assigned to “student 1” is shown.

Screen 410 depicts eight instances of template 412 based on template 409, which student 1 has to trace using a hand-drawn input. Instance 1 of the eight instances shows hand-drawn input 414 provided by student 1 corresponding to template 412 depicted in instance 1.

Hand-drawn inputs provided by students 1, 2, 3, and 4 are collected at devices 402 and transmitted to data processing system 404 as hand-drawn inputs 416. The application for analyzing all or a subset of hand-drawn inputs 416 analyzes the hand-drawn input groups and generates results 418. Results 418 correspond to results 320 in FIG. 3.

Screen 420 is an example display of results 418. In this example, screen 420 shows, such as to a teacher, student 1's hand-drawn input to template instance 1, labeled “Student 1-1,” student 2's hand-drawn input to template instance 1, labeled “Student 2-1,” and student 3's hand-drawn input to template instance 1, labeled “Student 3-1.” Student 4 may not have provided a hand-drawn input, or student 4's hand-drawn input may have been categorized to be analyzed differently.

Screen 420 further informs that student 1's hand-drawn input to template instance 1 has an accuracy of seventy two percent. Likewise, student 2's hand-drawn input to template instance 1 has an accuracy of sixty five percent, and student 3's hand-drawn input to template instance 1 has an accuracy of ninety one percent. Screen 420 also provides that accuracy of the hand-drawn inputs of the group, namely the hand-drawn inputs from students 1, 2, and 3, is seventy two percent.

Analysis performed to generate results 418 in this manner, and presented in the example form of screen 420 are advantageous according to an embodiment. Operating in this manner, an embodiment allows a teacher to get a comparative analysis of the performances of a group of students, shows the teacher which student might need assistance, which student is above or below an average level of the group, and the individual students' hand-drawn inputs. Example results 418, presented as screen 420, are not intended to be limiting on the illustrative embodiments. Those of ordinary skill in the art will be able to generate using this disclosure many other types of results 418 from well known analytical techniques, and the same are contemplated within the scope of the illustrative embodiments.

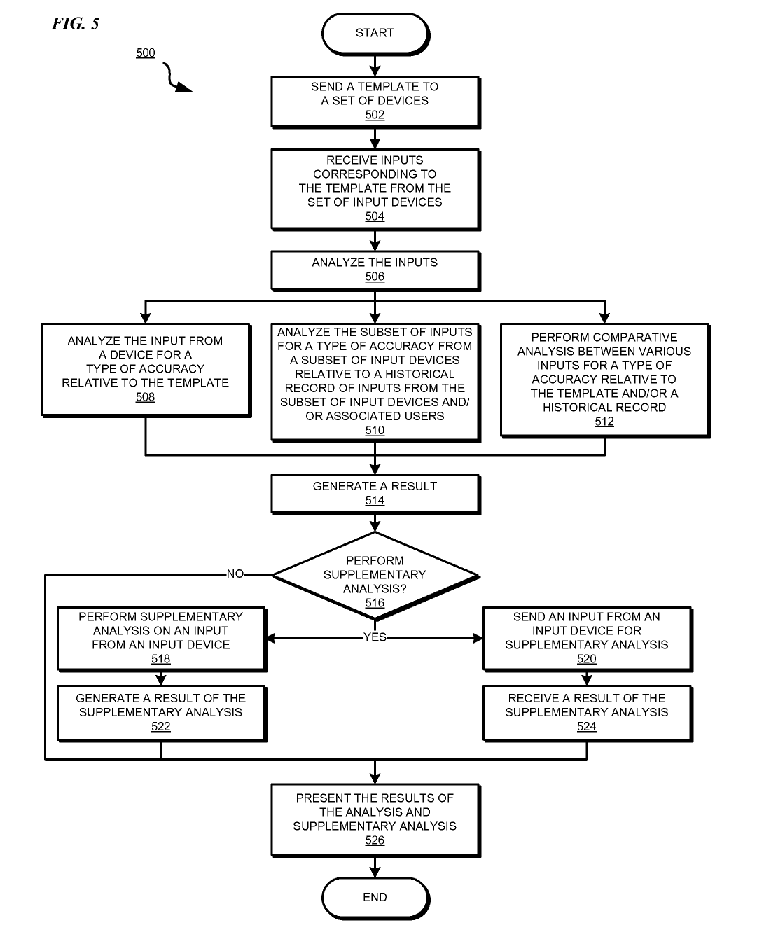

With reference to FIG. 5, this figure depicts a flowchart of an example process for analyzing hand-drawn input groups in accordance with an illustrative embodiment. Process 500 can be implemented in application 302 in FIG. 3.

Process 500 begins by sending a template to a set of devices capable of capturing hand-drawn inputs (step 502). Process 500 receives inputs corresponding to the template from the set of devices or a subset thereof (step 504).

Process 500 performs primary analysis of the inputs in any suitable manner as described with respect to FIG. 3 (step 506). As a part of the analysis of step 506, process 500 may analyze the hand-drawn input from a particular device for a particular type of accuracy relative to the template (step 508). For example, the analysis of step 508 may be for determining an accuracy of a shape in the hand-drawn input versus the shape in the template. As another example, the analysis of step 508 may be for determining an accuracy of a positioning or placement of a shape in the hand-drawn input versus the positioning or placement of the corresponding shape in the template. As another example, the analysis of step 508 may be for determining an accuracy of an intensity, pressure, or shading used in the hand-drawn input versus the intensity, pressure, or shading suggested by the template. Many other types of accuracies can be determined using suitable analysis rules in a similar manner.

Alternatively, or in conjunction with step 508, as a part of the analysis of step 506, process 500 may analyze a subset of the hand-drawn inputs for determining a type of accuracy relative to a historical record of hand-drawn inputs from the corresponding devices or users (step 510). For example, the analysis of step 510 may be for determining an improvement in the accuracy of a shape in subset of hand-drawn inputs versus the shapes in corresponding hand-drawn inputs recorded some time ago.

Alternatively, or in conjunction with steps 508 and 510, and as a part of the analysis of step 506, process 500 may perform a comparative analysis between various hand-drawn inputs for determining a type of accuracy relative to the template or a historical record of hand-drawn inputs (step 512). For example, the analysis of step 510 may be for determining level of difficulty experienced by a class in the accuracy of tracing a complex shape now versus the accuracy achieved by the class in tracing a simpler shape earlier.

Process 500 generates the results of one or more of analyses 508, 510, and 512 (step 514). Process 500 determines whether to perform any supplementary analysis, as described elsewhere in this disclosure (step 518).

If supplementary analysis is to be performed (“Yes” path of step 516), process 500 may perform a selected supplementary analysis on a hand-drawn input from a device (step 518). Alternatively, or in conjunction with step 518, process 500 may send a hand-drawn input to an external system for supplementary analysis (step 520).

If process 500 performs the supplementary analysis of step 518, process 500 generates the supplementary analysis results (step 522). If process 500 communicates with an external system for the supplementary analysis of step 520, process 500 receives the supplementary analysis results (step 524).

Process 500 presents the results generated in step 514, results generated in step 522, results received in step 524, or a combination thereof (step 526). Process 500 ends thereafter.

Returning to step 516, if no supplementary analysis is to be performed (“No” path of step 516), process 500 proceeds to step 526. Process 500 ends thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for analyzing hand-drawn input groups. Using an embodiment of the invention, accuracy of a hand-drawn input can be compared with a baseline, such as a template. An embodiment can also perform comparative analysis of several hand-drawn inputs in a group with one another. An embodiment can also help evaluate a user's performance by analyzing hand-drawn inputs from that user on various devices, templates, or a combination thereof. An embodiment can present a rolled-up view of accuracy ratings for groups of users based on each user's performance for similar templates. While some embodiments are described with respect to traceable shapes, colors, and intensity, an embodiment is similarly usable for vocabulary, sentence construction, reading comprehension, and other types of hand-drawn inputs.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable signal medium or a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like, conventional procedural programming languages, such as the “C” programming language or similar programming languages, and mainframe programming languages such as REXX, Assembly, and Cobol. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for analyzing hand-drawn input groups, comprising:
receiving from a set of computing devices a corresponding set of hand-drawn inputs, wherein a user in a group of users interacts with a device in the set of devices to provide a hand-drawn input in the set of hand-drawn inputs corresponding to the device;
analyzing a subset of the set of hand-drawn inputs to determine an accuracy of the hand-drawn inputs in the subset;
generating a result responsive to the analyzing; and
presenting the result.

2. The method of claim 1, wherein the analyzing comprises analyzing the subset of the set of hand-drawn inputs relative to a template to determine the accuracy of the hand-drawn inputs in the subset.

3. The method of claim 1, wherein the analyzing comprises analyzing the hand-drawn input relative to a historical hand-drawn input provided by the user to determine the accuracy of the hand-drawn input.

4. The method of claim 1, wherein the analyzing comprises analyzing the subset of hand-drawn inputs relative to a template and a set of historical hand-drawn inputs to determine the accuracy of the hand-drawn input.

5. The method of claim 1, further comprising:
sending a template to the set of devices, wherein the template includes a shape, and wherein the user traces the shape using the device to produce a tracing, a second shape of the tracing forming the hand-drawn input.

6. The method of claim 1, further comprising:
sending a template to the set of devices, wherein the template includes a shape, and wherein the user traces the shape using the device to produce a tracing, a placement of the tracing forming the hand-drawn input.

7. The method of claim 1, further comprising:
sending a template to the set of devices, wherein the template includes a suggestion of a color, and wherein the user selects a second color using the device to produce a tracing, the second color forming the hand-drawn input.

8. The method of claim 1, further comprising:
sending a template to the set of devices, wherein the template includes a suggestion of a pressure value to be applied to the device, and wherein the user selects a second pressure value to apply to the device, the second pressure value forming the hand-drawn input.

9. The method of claim 1, further comprising:
performing a supplementary analysis, wherein the supplementary analysis analyzes the hand-drawn input to identify a disorder in the user.

10. The method of claim 1, wherein the group of users is a group of students, wherein the result is a comparative evaluation of writing performance of the students.

11. The method of claim 1, wherein the group of users is a group of patients, wherein the result is a comparative evaluation of motor control performance of the patients.

12. A computer usable program product comprising a computer usable storage medium including computer usable code for analyzing hand-drawn input groups, the computer usable code comprising:
computer usable code for receiving from a set of computing devices a corresponding set of hand-drawn inputs, wherein a user in a group of users interacts with a device in the set of devices to provide a hand-drawn input in the set of hand-drawn inputs corresponding to the device;
computer usable code for analyzing a subset of the set of hand-drawn inputs to determine an accuracy of the hand-drawn inputs in the subset;
computer usable code for generating a result responsive to the analyzing; and
computer usable code for presenting the result.

13. The computer usable program product of claim 1, wherein the computer usable code for analyzing comprises computer usable code for analyzing the subset of the set of hand-drawn inputs relative to a template to determine the accuracy of the hand-drawn inputs in the subset.

14. The computer usable program product of claim 1, wherein the computer usable code for analyzing comprises computer usable code for analyzing the hand-drawn input relative to a historical hand-drawn input provided by the user to determine the accuracy of the hand-drawn input.

15. The computer usable program product of claim 1, wherein the computer usable code for analyzing comprises computer usable code for analyzing the subset of hand-drawn inputs relative to a template and a set of historical hand-drawn inputs to determine the accuracy of the hand-drawn input.

16. The computer usable program product of claim 1, further comprising:
computer usable code for sending a template to the set of devices, wherein the template includes a shape, and wherein the user traces the shape using the device to produce a tracing, a second shape of the tracing forming the hand-drawn input.

17. The computer usable program product of claim 1, further comprising:
computer usable code for sending a template to the set of devices, wherein the template includes a shape, and wherein the user traces the shape using the device to produce a tracing, a placement of the tracing forming the hand-drawn input.

18. The computer usable program product of claim 12, wherein the computer usable code is stored in a computer readable storage medium in a data processing system, and wherein the computer usable code is transferred over a network from a remote data processing system.

19. The computer usable program product of claim 12, wherein the computer usable code is stored in a computer readable storage medium in a server data processing system, and wherein the computer usable code is downloaded over a network to a remote data processing system for use in a computer readable storage medium associated with the remote data processing system.

20. A data processing system for analyzing hand-drawn input groups, the data processing system comprising:
a storage device including a storage medium, wherein the storage device stores computer usable program code; and
a processor, wherein the processor executes the computer usable program code, and wherein the computer usable program code comprises:
computer usable code for receiving from a set of computing devices a corresponding set of hand-drawn inputs, wherein a user in a group of users interacts with a device in the set of devices to provide a hand-drawn input in the set of hand-drawn inputs corresponding to the device;
computer usable code for analyzing a subset of the set of hand-drawn inputs to determine an accuracy of the hand-drawn inputs in the subset;
computer usable code for generating a result responsive to the analyzing; and
computer usable code for presenting the result.
